(19) United States
(12) Patent Application Publication
(10) Pub. No.: US 2016/0242584 A1
(43) Pub. Date: Aug. 25, 2016

(54) UTENSIL INCLUDING GRIPPING ELEMENT

(71) Applicant: John Ramshaw, Mountain House, CA (US)

(72) Inventor: John Ramshaw, Mountain House, CA (US)

(21) Appl. No.: 15/042,736

(22) Filed: Feb. 12, 2016

Related U.S. Application Data
(60) Provisional application No. 62/118,100, filed on Feb. 19, 2015.

(51) Int. Cl. A47G 21/02; A47J 43/18

(52) U.S. Cl. CPC A47G 21/02; A47J 43/18

(57) ABSTRACT

A utensil that includes a handle portion coupled with an end piece or gripping element, wherein the end piece or gripping element includes a concave gripping surface, either curved and/or V-shaped, including a plurality of serrations for gripping and immobilizing a rib or other bone with meat on it. The end piece or gripping element may be attached to or include a plurality of tines, or it may be attached to or include other features, such as a knife feature a spoon feature or a spork feature (e.g., a spoon with smaller tines).

### CROSS-REFERENCE TO RELATED APPLICATIONS

This patent application claims the benefit of U.S. Provisional Patent Application No. 62/118,100, filed Feb. 19, 2015, which is incorporated herein by reference.

### BACKGROUND AND SUMMARY

The present disclosure relates generally to utensils, and more particularly to utensils that facilitate gripping and immobilizing bones with edible meat on them, such as beef, pork, and lamb ribs, poultry drumsticks, thighs, and wings, etc., to facilitate cutting off the meat.

According to an embodiment, a utensil is provided that typically includes a handle portion, and an end piece coupled with a first end of the handle portion, wherein the end piece comprises a gripping element that includes at least one gripping surface having a plurality of serrations. In certain aspects, the end piece includes at least two gripping surfaces, each having a plurality of serrations. In certain aspects, the utensil further includes a second end piece coupled to a second end of the handle portion distal from the first end of the handle portion, the second end piece including at least one gripping surface having a plurality of serrations. In certain aspects, a gripping surface includes a concave surface. In certain aspects, a gripping surface includes a curved surface. In certain aspects, a gripping surface includes a V-shaped portion or surface. In certain aspects, an end piece includes a plurality of tines or is coupled with a plurality of tines. In certain aspects, the end piece includes a gripping or clamping mechanism comprised of two hinged opposing serrated jaws. In certain aspects, the gripping or clamping mechanism is capable of being manually adjusted, e.g., loosened or tightened.

According to an embodiment, a utensil is provided that typically includes a handle portion, and a gripping element coupled with a first end of the handle portion, wherein the gripping element includes at least one gripping surface having a plurality of serrations. In certain aspects, the gripping element includes at least two gripping surfaces, each having a plurality of serrations. In certain aspects, the utensil further includes a second gripping element coupled to a second end of the handle portion distal from the first end of the handle portion, the second gripping element including at least one gripping surface having a plurality of serrations. In certain aspects, a gripping surface includes a concave surface. In certain aspects, a gripping surface includes a curved surface. In certain aspects, a gripping surface includes a V-shaped portion or surface. In certain aspects, a gripping element includes a plurality of tines or is coupled with a plurality of tines.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIGS. 1A and 1C illustrate a side view and FIG. 1B illustrates a top view, respectively, of a utensil having a handle attached to an end piece with a gripping surface having serrations, according to an embodiment.

FIGS. 2A and 2B illustrate a side view of two alternative utensil embodiments.

FIG. 3A shows a top view, and FIGS. 3B and 3C show a side view, of embodiments of a utensil including fork tines and a gripping element.

FIGS. 3D and 3E show side and bottom views, respectively, of another embodiment of a utensil including fork tines and a gripping element.

FIGS. 3F and 3G show side and bottom views, respectively, of another embodiment of a utensil including fork tines and a gripping element.

FIGS. 3H and 3I show side and bottom views, respectively, of another embodiment of a utensil including fork tines and a gripping element.

### DETAILED DESCRIPTION

The present disclosure relates generally to utensils, and more particularly to utensils that facilitate gripping and immobilizing bones with edible meat on them, such as beef, pork, and lamb ribs, poultry drumsticks, thighs, and wings, etc., to facilitate cutting off the meat.

Ribs (e.g., pork ribs, beef ribs, etc.) are often eaten with the fingers, but when they are tender enough that the meat easily separates from the bone, many people may prefer to eat them with a knife and fork, which is less messy. However, this can be difficult and awkward to do because a fork is not designed to effectively penetrate the rib to immobilize the rib. Hence, it is desirable to provide a tool or utensil to facilitate immobilization of a rib or similar food product.

According to an embodiment, a utensil is provided to hold down and immobilize a food item such as a bone (e.g., rib) so that the meat on the bone can be cut off using a knife held in the other hand. The utensil can also be used to immobilize other types of food items or bones for the same purpose, such as those in poultry, steaks, and chops.

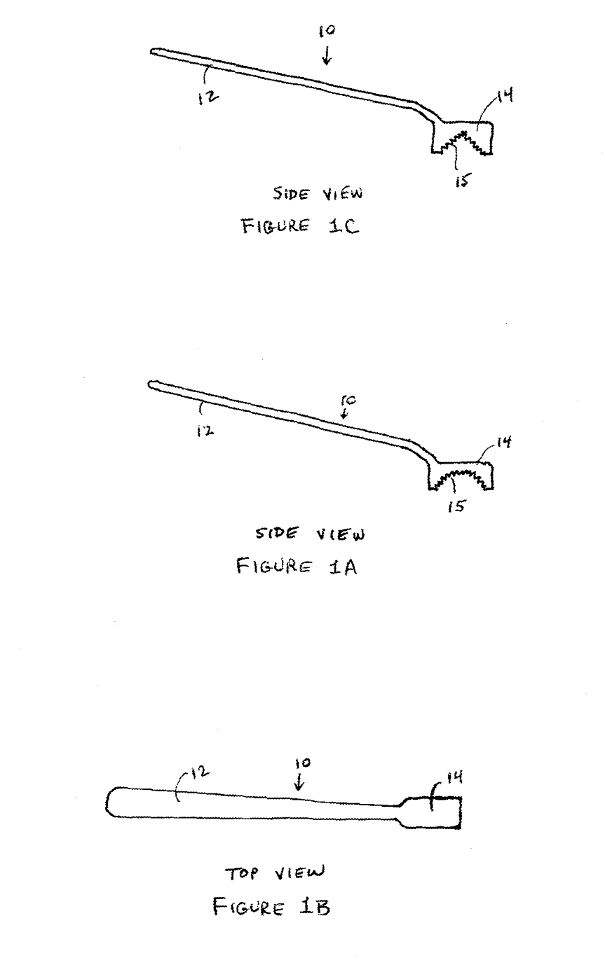

FIG. 1 illustrates a utensil 10 according to an embodiment. Utensil 10 includes a handle (also referred to as handle portion) 12 attached to an end piece 14 as shown in FIG. 1. In certain aspects, utensil 10 includes no moving parts. A lower or bottom surface of the end piece 14 includes a serrated gripping surface or gripping element 15 which is concave, either curved and/or V-shaped as shown in FIG. 1A or FIG. 1C, so as to facilitate immobilizing a bone, e.g., rib, against a surface (e.g., a plate) when pressed down onto the bone.

The end piece 14, in certain aspects, is tilted slightly backward relative to the handle, so that the handle is slightly elevated above the table at a convenient angle when the gripping surface is horizontal as shown in the side view of FIG. 1A or FIG. 1C. FIG. 1B shows a top view of the utensil 10. In certain aspects, the end piece 14 is about an inch long, half an inch wide, and a quarter of an inch thick, although other dimensions may be used. The end piece 14 may be made of the same material as the handle (e.g., integrally formed together with the handle) or a different material (e.g., attached or connected to the handle), and the end piece 14 may be solid, or it may be hollowed out.

In one embodiment, a tilt angle between the handle 12 and the end piece 14 is made adjustable or variable by means of a suitable mechanical linkage, e.g., by including a hinge, pivot, or ball joint (not shown) linking the handle 12 and the end piece 14, such that the tilt angle can be changed manually, e.g., by loosening and then retightening the joint by twisting, sliding, or otherwise manipulating a suitable mechanical constraint mechanism (not shown) including, e.g., a wing nut or thumbscrew. Alternatively, the tilt angle can be allowed to vary freely as the user readjusts and realigns the position of the arm and hand holding the utensil.

In other embodiments, the end piece 14 includes two hinged serrated jaws similar in shape, design, and functionality to those of various common types of pliers (e.g., goose neck, tongue & groove, or groove joint pliers). In certain such embodiments, the jaws are held apart by a biasing mechanism (not shown; e.g., a spring or other biasing element) until they are forced to close or clamp down on the rib or other bone and thereby grip it more firmly by applying pressure to the handle. In other such embodiments, the jaws are held closed by a biasing mechanism (not shown; e.g., a spring element similar to those used in clothes pins or other common types of spring clamps) until they are forced open by squeezing together or otherwise applying pressure to extended lever arms (e.g., by squeezing them between the thumb and forefinger in the same manner one opens a clothes pin or other spring clamp) until the jaws are positioned to close or clamp down on the bone, whereupon the lever arms are then released to allow the spring element to force the jaws to close and tighten on the bone. In yet another embodiment, the jaws can be manually opened and closed by a mechanical mechanism of the same or similar design as that used in vise grip pliers. Other variations, modifications, and/or equivalents to such clamping mechanisms will be apparent to one skilled in the art.

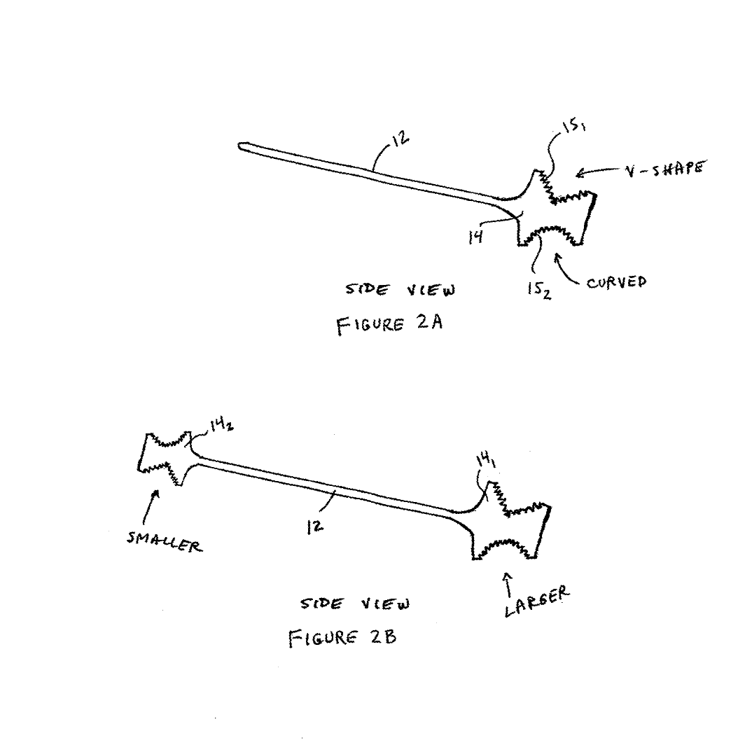

In one embodiment, utensil 10 includes two or more different gripping surfaces. Each gripping surface may have the same or different shapes and/or sizes and/or serration pattern. For example, in one embodiment, multiple, e.g., two, three or four different gripping surfaces could be provided on one end of the handle 12, or on each end of the handle 12, thereby providing a single utensil with the flexibility to deal with several different types and sizes of ribs or other bones, ranging from chicken wings to beef ribs. Two illustrative designs are shown in FIG. 2. For example, FIG. 2A shows a side view of a utensil having an end piece 14 with two gripping surfaces: surface 15₁ includes a V-shaped gripping surface (serrations arranged at a V-shaped angle as shown) and surface 15₂ includes a curved gripping surface (serrations arranged along a curved surface as shown). FIG. 2B shows a side view of a utensil having a first end piece 14₁ with two gripping surfaces and a second end-piece 14₂ distal from the first end piece 14ₖ, with two gripping surfaces. End piece 14₁ may be larger than the end piece 14₂ as shown, e.g., the gripping surfaces of end piece 14₁ may be larger than the gripping surfaces of end piece 14₂. Although not shown, three or four gripping surfaces can be provided on either one or both ends of the handle 12. In certain aspects, the handle 12 could have a contour that is round or square with rounded corners, rather than flat.

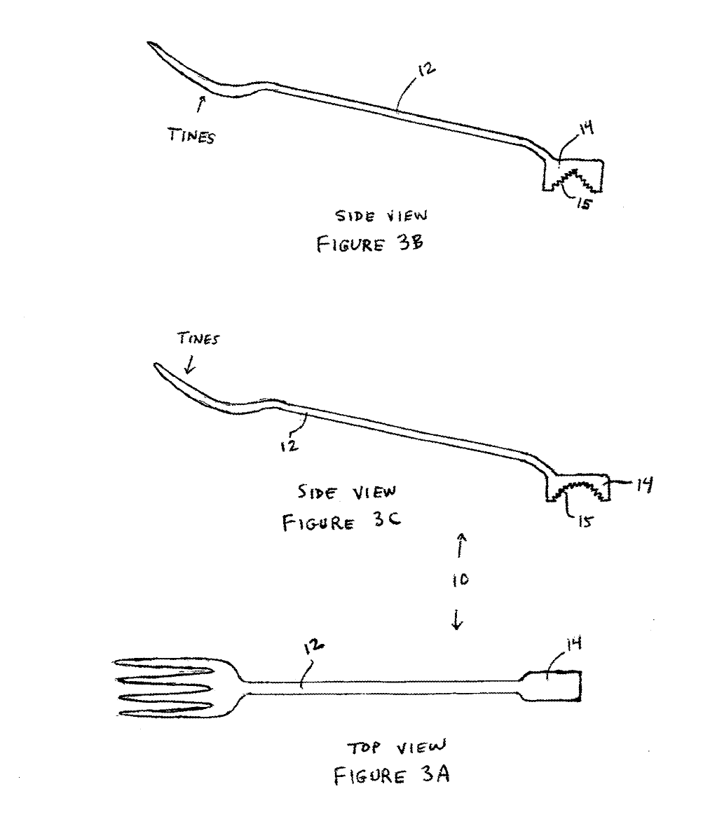

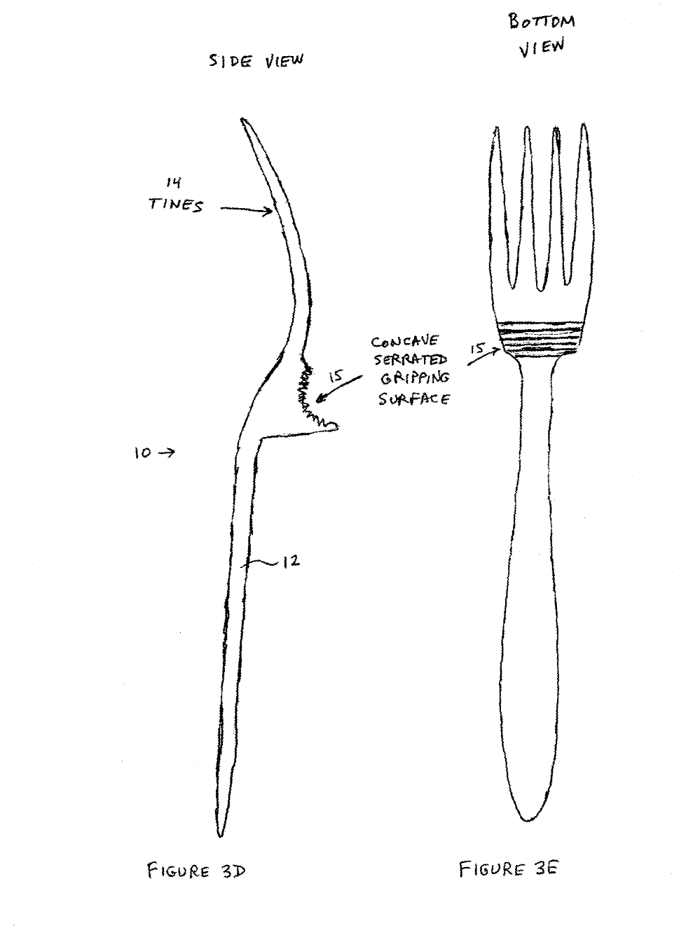

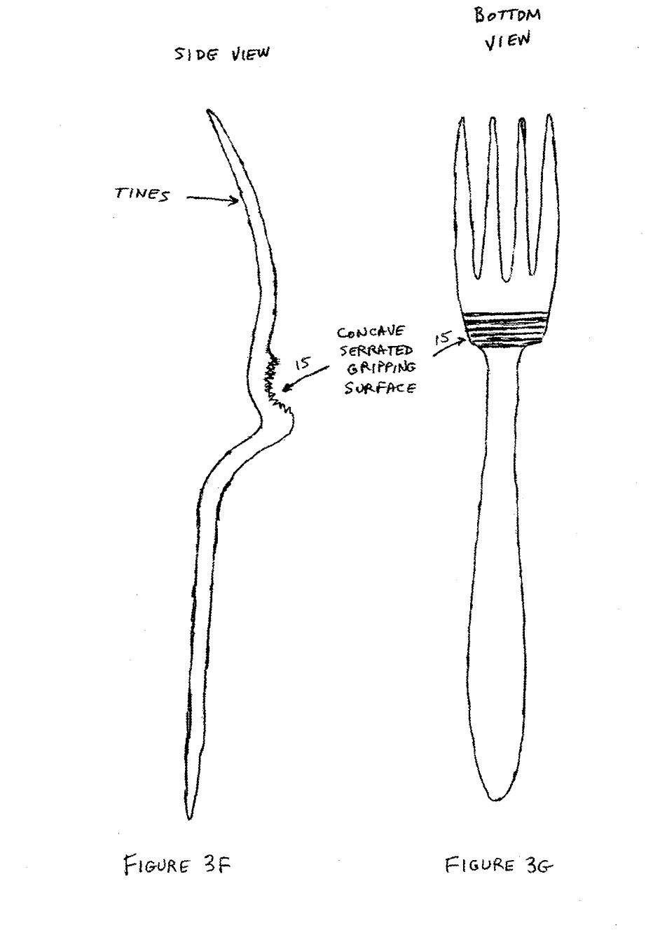

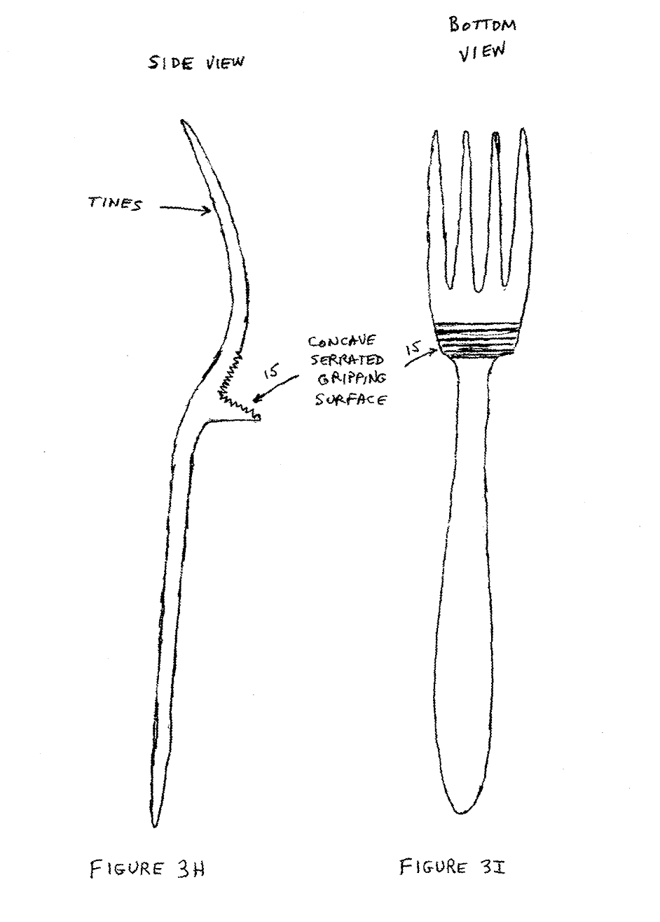

In another embodiment, a concave curved or V-shaped serrated gripping surface of the type already described is combined with or attached to a conventional fork, so that the functionality of both utensils is conveniently and simultaneously provided by a single utensil with a single handle. This can be done either by placing or attaching the gripping surface (e.g., V-shaped, or curved as shown in FIGS. 3B and 3C, respectively) at one end of the handle and the fork tines at the other end, as illustrated in FIGS. 3A-3C, or by placing or attaching the gripping surface 15 to the underside of the fork, e.g., at the intersection of the handle 12 and end-piece (or tine structure) as shown in FIGS. 3D and 3E. The design shown in FIGS. 3D and 3E is particularly convenient and advantageous, as it allows the user to effortlessly switch between the fork and grabber or gripping functionality without putting down or rotating the utensil. For example, a right-handed person would typically hold a knife in the right hand and the combined grabber/fork utensil 10 in the left hand, where utensil 10 can be used both to hold down and immobilize the rib or similar food item for cutting by the knife, and then to spear the resulting cut piece or pieces with the fork tines for eating.

FIGS. 3F and 3G show a slight variant on the design shown in FIGS. 3D and 3E, which has the advantage that it uses less metal and may be cheaper to manufacture. FIGS. 3H and 31 show yet another variant or embodiment of the design, in which the concave gripping surface attached to the fork is L-shaped (e.g., has a substantially 90 degree angle) rather than curved as shown in FIGS. 3D through 3G. It should be appreciated that the angle may be greater than or less than 90 degrees.

According to an embodiment, a utensil is provided that includes a handle portion coupled with an end piece or gripping element, wherein the end piece or gripping element includes a concave gripping surface, either curved and/or V-shaped, including a plurality of serrations for gripping and immobilizing a rib or other bone with meat on it. The end piece or gripping element may be attached to or include a plurality of tines, or it may be attached to or include other features, such as a knife feature a spoon feature or a spork feature (e.g., a spoon with smaller tines).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Certain embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A utensil, comprising:
a handle portion; and
an end piece coupled with a first end of the handle portion, the end piece comprising a gripping surface having a plurality of serrations.

2. The utensil of claim 1, wherein the end piece includes at least two gripping surfaces, each having a plurality of serrations.

3. The utensil of claim 1, further comprising a second end piece coupled to a second end of the handle portion distal from the first end, the second end piece including a gripping surface having a plurality of serrations.

4. The utensil of claim 1, wherein the gripping surface includes a concave surface.

5. The utensil of claim 1, wherein the gripping surface includes a V-shaped surface.

6. The utensil of claim 1, wherein the gripping surface includes a curved surface.

7. The utensil of claim 1, wherein the end piece is integrally formed with the handle portion and comprises the same material as the handle portion.

8. The utensil of claim 1, wherein the end piece includes a plurality of tines.

9. The utensil of claim 1, wherein the end piece is coupled with a plurality of tines.

10. The utensil of claim 1, further including an adjustment mechanism for adjusting an angle of tilt between the handle portion and the end piece.

11. The utensil of claim 1, wherein the end piece includes a gripping or clamping mechanism comprised of two hinged opposing serrated jaws.

12. The utensil of claim 11, wherein the gripping or clamping mechanism is capable of being manually adjusted.

13. A utensil, comprising:
a handle portion; and
a gripping element coupled with a first end of the handle portion, the gripping element comprising a gripping surface having a plurality of serrations.
